(19) United States
(12) Patent Application Publication
(10) Pub. No.: US 2026/0088028 A1
(43) Pub. Date: Mar. 26, 2026

(54) Automatic Control of a Function of a Motor Vehicle

(71) Applicant: Bayerische Motoren Werke Aktiengesellschaft, Muenchen (DE)

(72) Inventors: Ahmet FIRINTEPE, Karlsfeld (DE); Fabian Humberto Fonseca Aponte, Muenchen (DE); Soumy Jacob, Unterschleissheim (DE)

(21) Appl. No.: 19/308,904

(22) Filed: Aug. 25, 2025

(30) Foreign Application Priority Data
Sep. 25, 2024 (DE) 10 2024 127 733.5

(51) Int. Cl. G10L 15/22; B60R 16/037; G10L 15/18

(52) U.S. Cl. CPC G10L 15/22; B60R 16/0373; G10L 15/18; G10L 2015/223

(57) ABSTRACT

A method for controlling a function of a motor vehicle comprises steps of recording a linguistic description of conditional function execution; wherein the description includes a condition and a function of the motor vehicle to be executed when the condition is met; determining a first embedding on the basis of the condition by means of an LLM; determining parameters of a situation of the motor vehicle; determining a second embedding on the basis of the parameters; and automatically executing the function when the first embedding has a predetermined similarity to the second embedding.

This application claims priority under 35 U.S.C. §119 from German Patent Application No. DE 102024127 733.5, filed September 25, 2024, the entire disclosure of which is herein expressly incorporated by reference.

### BACKGROUND AND SUMMARY

The present invention relates to the control of a function of a motor vehicle. In particular, the invention relates to the automatic control of such a function.

A motor vehicle comprises a multiplicity of functions that can be controlled by a person on board. Examples of functions include, playing a predetermined piece of music on an entertainment system or adjusting a ventilation system (Heating, Venting, Air Conditioning, HVAC). Controlling the function can require setting multiple parameters and may therefore be complex.

To make it easier to control such a function, use of a voice assistant has been suggested. A person on board the motor vehicle may name a predetermined function and specify a parameter to be set. The function can then be controlled accordingly. However, the linguistic control of the function can also be complex and therefore laborious for the person.

It has also been suggested that a function of the motor vehicle be automatically controlled when a predetermined condition is met. In practice, it has been proven that defining such a condition is also complicated and error-prone. The function is often controlled by mistake or not controlled by mistake with respect to an intention of the person.

One object on which the present invention is based is to provide an improved technique for automatically controlling a function on board a motor vehicle. Forms of the invention achieves this object by means of the subjects of the independent claims. Subclaims describe preferred embodiments.

According to a first aspect of the present invention, a method for controlling a function of a motor vehicle comprises steps of recording a linguistic description of conditional function execution; wherein the description includes a condition and a function of the motor vehicle to be executed when the condition is met; determining a first embedding on the basis of the condition by means of an LLM; determining parameters of a situation of the motor vehicle; determining a second embedding on the basis of the parameters; and automatically executing the function if the first embedding has a predetermined similarity to the second embedding.

The LLM, as a large language model, is configured to process natural language. Various LLMs have been published that can be used to implement the technique proposed herein. Converting the linguistically formulated condition into an embedding makes it possible for an actual intention of a person setting up the condition to be determined in an improved manner. In particular, a vagueness of the linguistic description can also be represented. For example, if the description includes the condition "when the weather is good", many different situations that can lead to a determination of "good" weather are conceivable. Converting the parameters into the second embedding makes it possible to use different information sources, from which it can be deduced whether or not the predetermined condition is met. In the given example, the quality of prevailing weather can be determined, for example, on the basis of a temperature, a humidity, a wind speed, precipitation or an air pressure. On the basis of completely different parameters, it can also be determined that good weather prevails when a top of the motor vehicle is open, while at the same time a heating system of the motor vehicle is deactivated. The LLM can determine the embeddings in such a way that their similarities can be correctly determined despite the vagueness. The function of the motor vehicle can thus be executed automatically with improved accuracy if the described condition is met.

The method can be used to execute virtually any function of the motor vehicle. Examples of functions concern the opening or closing of a window, the operation of an entertainment system, the operation of an air conditioning system (HVAC) or the operation of a comfort function such as a seat adjustment. Optionally, it is also possible to control a function relevant to the movement of the motor vehicle, for example the activation of exterior lighting. The control and operation can theoretically be as complex as desired. In practice, the complexity is limited in terms of the linguistic complexity of the description.

The situation is preferably determined on the basis of a driving state of the motor vehicle. For example, the situation can be determined periodically or continuously while the motor vehicle is actively in use. Examples of driving states include an unlocked state, a state with a person on board, a state ready for driving and a state during which the motor vehicle is driving. In different driving states, the situation can be determined with different frequencies or on the basis of different parameters. The frequency or a selection of parameters can be assigned to a driving state.

In some implementations, the description is recorded and processed in the form of an acoustic utterance by the person. In one embodiment, the acoustic utterance by the person can be converted into text form. A technique known as speech-to-text (STT) can be used for this purpose. Alternatively, it is possible to use a multimodal LLM which is configured to process acoustic utterances.

The possibility of an acoustic utterance makes it easier for the person to provide a linguistic description, in particular while on board the motor vehicle. If the person is a driver of the motor vehicle, the driver may provide the linguistic description while driving the motor vehicle without being excessively distracted from his driving task.

An embedding usually includes a vector in a vector space with a large number of dimensions. The vector cannot have a defined value for all intended dimensions. In principle, similarities between two embeddings can be determined in the same way as similarities between two vectors. In particular, a distance between the ends of the vectors or embeddings can be used as a measure of dissimilarity. The smaller the distance, the smaller the dissimilarity and the more similar the vectors or embeddings are. The similarity of the embeddings can be determined, for example, on the basis of a Euclidean distance, a scalar product, a cosine similarity or a Manhattan metric. Different degrees of similarity can be used for differently vague definitions of a condition or situation.

The situation may comprise at least one of a driving state of the motor vehicle, weather prevailing in the region of the motor vehicle, a person on board the motor vehicle, a planned route and a destination of the motor vehicle. It should be noted that the situation of the motor vehicle may have yet further characteristics.

The driving state may include, for example, a geographical position or a driving speed of the motor vehicle. Furthermore, the driving state may include a traffic volume in the region of the motor vehicle, an activated driving mode, an activated control function of the motor vehicle, a date, a time or a day of the week. The weather may include, in particular, precipitation, an air temperature, a humidity, an air pressure, wind and/or sunlight. Examples of destinations include a work route, a holiday route, a school trip and a leisure trip.

In a further embodiment, environment information relating to the motor vehicle, which cannot be captured in particular by a sensor on board the motor vehicle, is determined. The second embedding can be determined on the additional basis of the environment information.

The environment information can be obtained in particular from an information source external to the motor vehicle. For example, such an information source can include a server or a service, for example in a computer cloud. For example, information about a traffic flow on a planned route of the motor vehicle can be obtained from such an external information source. Another example of an external information source includes a weather service that can provide prevailing weather at a predetermined position.

In one embodiment, an information source for the environment information is determined on the basis of the condition. For this purpose, it is possible to use a capability of the LLM that is known as reasoning. When processing the description, the LLM can determine an external information source that can be consulted in order to determine the content of a linguistic input or the subject of an output in response to an input. For example, if the condition includes a reference to prevailing weather, a weather service can be identified as an external information source. The situation of the motor vehicle can then be determined taking into account weather provided by the weather service. A current geographical position of the motor vehicle can be passed on to the weather service as a parameter for weather to be determined. The LLM can also determine a possible parameter for the external information source.

In one development of the invention, a probable situation of the motor vehicle can be predicted. A predetermined future can be assumed as a prediction horizon. This can be used to control a function in anticipation of the occurrence of a predetermined situation. For example, a top of the motor vehicle can be closed if it is likely to rain within a predetermined prediction horizon of, for example, approximately 1 hour, and not only when it has already started to rain. A block heater of the motor vehicle can be activated if use of the motor vehicle is expected within a predetermined prediction horizon.

Whether the use of the motor vehicle is likely within the prediction horizon can be determined, for example, on the basis of past observations of regular use. For example, work routes with the motor vehicle may be subject to a predetermined rhythm that can be easily determined based on past use. The motor vehicle can be prepared proactively for a likely impending use of the motor vehicle. In this example, a function of the motor vehicle is controlled without a person being on board the motor vehicle. Functions that can be executed in this driving state can be limited.

According to a further aspect of forms of the present invention, a control system for controlling a function of a motor vehicle comprises an input device for recording a linguistic description of conditional function execution; wherein the description includes a condition and a function of the motor vehicle to be executed when the condition is met; at least one sensor for determining parameters of a situation of the motor vehicle; an interface to an LLM, which is configured to determine a first embedding on the basis of the condition and a second embedding on the basis of the parameters; and a processing device which is configured to execute the function if the first embedding has a predetermined similarity to the second embedding.

The processing device is preferably configured to partly or fully carry out a method described herein. For this purpose, the processing device may be of electronic design and include, for example, an integrated circuit, a programmable logic chip or a programmable microcomputer. The method may be implemented in the form of a configuration or as a computer program product with program code means for the processing device. The configuration or the computer program product may be stored on a computer-readable data carrier. Features or advantages of the method can be transferred to the apparatus, or vice versa.

In one embodiment, the LLM is implemented outside the motor vehicle, and the interface may allow wireless communication between the motor vehicle and the LLM. The LLM can be implemented in particular on a server or as a service, in particular in a cloud. In another embodiment, the LLM is included in the control system. In this case, the control system and the LLM may be on board the motor vehicle. In one embodiment, use is made of an LLM which is specifically trained for the processing of conditions, functions and situations of the motor vehicle. Such an LLM may be implemented on board the motor vehicle using available means in terms of processing capacity and storage space, for example by means of the processing device mentioned.

In a further embodiment, a vector-oriented database for storing embeddings is included in the control system. The database is configured to determine a similarity between stored embeddings. The database, like the LLM, may be alternatively provided on board the motor vehicle or on a device external to the motor vehicle. Preferably, the LLM and the vector-oriented database are integrated with each other and are executed in particular on the same processing system. For example, Chroma, which is freely available as an open source product, can be used as a database. Similarities between stored embeddings can be inherently determined by the vector-oriented database. For example, it is possible to search for an embedding similar to another embedding. The database can also determine a degree of similarity or determine whether an embedding has a predetermined similarity to another embedding.

The control system may comprise an interface to an information source remote from the motor vehicle. The information source is configured to provide environment information for the motor vehicle. It is possible to define a number of predetermined remote information sources which can provide e.g. traffic information, weather information, etc. An external information source may provide information relating to a geographical position and/or a time. An information source may provide information, in particular, regarding a current or planned geographical position of the motor vehicle, or a current, historical or future time.

According to yet another aspect of forms of the present invention, an apparatus for a motor vehicle comprises a device for determining that a situation of the motor vehicle has a predetermined similarity to a predetermined condition; wherein a first embedding is assigned to a linguistic description of the condition and a second embedding is assigned to parameters of the situation; and a control device for controlling a predetermined function of the motor vehicle, which is associated with the condition, if the first embedding has a predetermined similarity to the second embedding.

The apparatus can be considered to be a local part of a control system described herein. In different embodiments, a further element of the control system may be alternatively provided on board the motor vehicle or outside the motor vehicle, in particular at an external location.

According to yet another aspect of the present invention, a motor vehicle comprises an apparatus described herein. The motor vehicle may include, in particular, an automobile or a motorcycle.

The invention will now be described in more detail with reference to the attached drawings.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a control system; and

FIG. 2 illustrates a flowchart of a method.

### DETAILED DESCRIPTION OF THE DRAWINGS

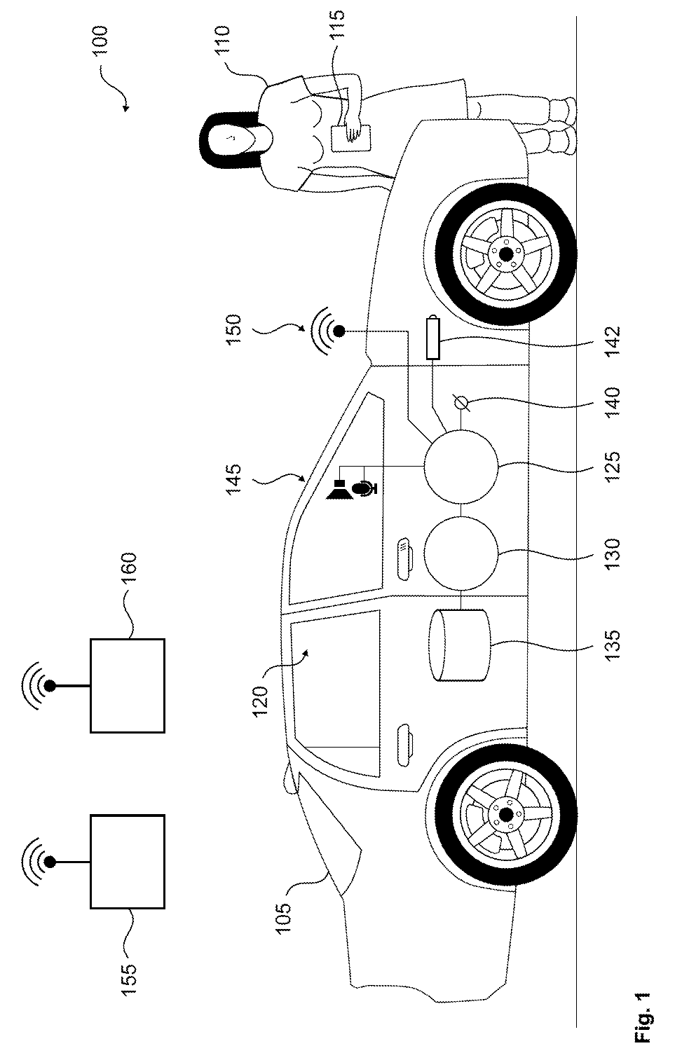

FIG. 1 shows a control system 100 for controlling a predetermined function of a motor vehicle 105. The control system 100 is configured to automatically control the predetermined function when a condition associated with the function is met. The condition and the function can be specified by a person 110 assigned to the motor vehicle 105. In one embodiment, the person 110 may use a user interface on board the motor vehicle 105 to store the definition. In another embodiment, the person 110 uses another device for this purpose, in particular a mobile device 115, particularly preferably a smartphone. For this purpose, the mobile device 115 can exchange information with the motor vehicle 105.

On board the motor vehicle 105 there is an apparatus 120 having a plurality of components, some of which may also be arranged outside the motor vehicle 105 within the framework of the control system 100. First, a description is given of a variant of the control system 100 which can be used completely in the form of the apparatus 120 on board the motor vehicle 105.

In this embodiment, the apparatus 120 comprises a processing device 125, an LLM 130, a vector-oriented database 135, an interface 140 for connection to a further device on board the motor vehicle 105, at least one sensor 142 and a user interface 145.

The sensor 142 is configured to provide one or more parameters that can give an indication of a situation of the motor vehicle 105. The situation can be defined by a number of parameters, one of which can come from a sensor 142. Optionally, the sensor 142 is part of another device on board the motor vehicle 105 and is connected via the interface 140. The other device can also function as a sensor. Examples of sensors include a position sensor, a speed sensor, a sensor for determining a driving state. An exemplary device, which can function as a sensor 142, comprises a control unit for a drive motor of the motor vehicle 105. Provided parameters may here include, for example, a provided torque, a gear engaged or a remaining amount of energy in an onboard energy store.

The user interface 145 is configured to be used by the person 110. The user interface 145 can be acoustically designed such that the person 110 can make an input using spoken language. Optionally, an acoustic output to the person 110 by means of spoken language can be provided. In another embodiment, the user interface 145 is configured to process text input by the person 110. Feedback can also be given in text form.

If the LLM 130 processes text data while speech data have been provided via the user interface 145, the processing device 125 can convert the speech into text. In the opposite direction, a response provided by the LLM 130 in text form can be converted into speech form by the processing device 125. If the user interface 145 is acoustically designed, it is preferred for the LLM 130 to be able to work directly on acoustic data. A multimodal LLM 130 can be used for this purpose.

The database 135 is configured to store an embedding, which is determined in particular by the LLM 130, and optionally to determine a similarity between the stored embedding and a further embedding. The similarity can be specified on a predetermined scale, for example between zero (dissimilar) and one (very similar or matching).

Via the interface 140, a further device on board the motor vehicle 105 can be actuated to control or initiate a predetermined function of the motor vehicle 105. The further device may include, for example, an entertainment system, a seat adjustment, a lighting device or a ventilation system.

In some embodiments, a communication device 150 is provided, by means of which the apparatus 120 can communicate with another device. The communication device 150 is preferably wireless and can in particular support mobile radio or WiFi. In one embodiment, a mobile device 115 can be connected via the communication device 150 in order to function as a user interface 145. In another embodiment, contact can be made with an external information source 155 by means of the communication device 150. The external information source 155 can provide in particular parameters relating to a situation in the surroundings of the motor vehicle 105. As a parameter, the information source 155 can process a geographical position of the motor vehicle 105 and/or a time to which the desired information is related. A current position of the motor vehicle 105 can be determined by means of a positioning device, not shown, which may comprise in particular a receiver for a satellite-based global navigation system (GNSS).

In a further embodiment, one or more of the described elements of the apparatus 120 may also be provided at an external location 160, with which the apparatus 120 can communicate by means of the communication device 150. For example, the external location 160 can house the LLM 130. The database 135 is preferably provided where the LLM 130 is provided, that is to say by the external location 160 in this embodiment.

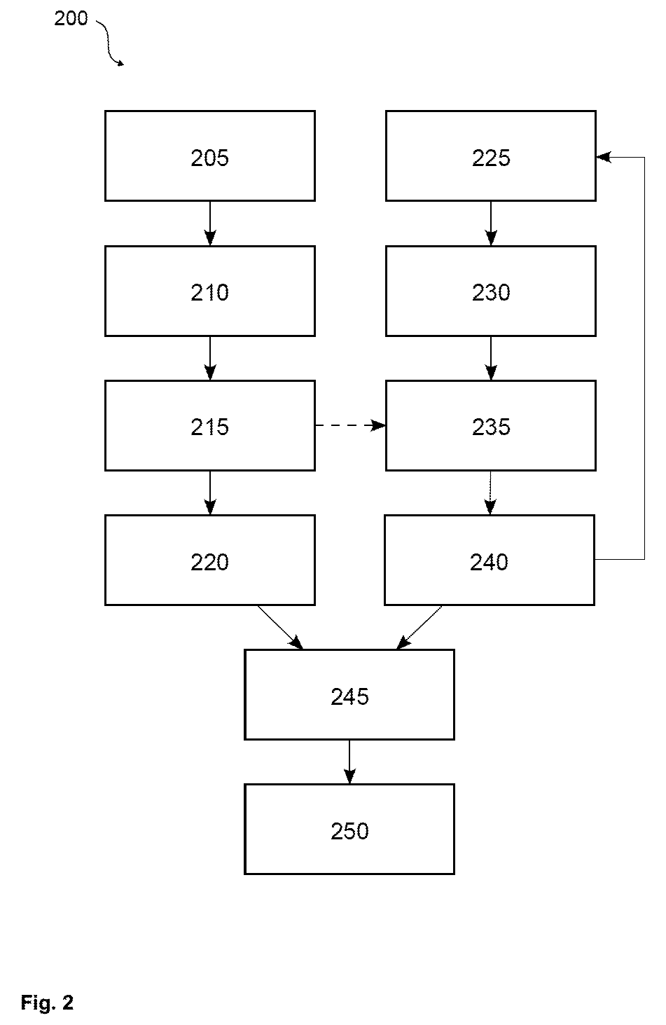

FIG. 2 shows a flowchart of a method 200 which can be carried out in particular by means of a control system 100.

In a step 205, an utterance by the person 110 can be recorded. The utterance may include a linguistic description of conditional function execution to be defined for a motor vehicle 105. Instead of an utterance by means of spoken language, text-based processing may also be provided, as described herein.

In a step 210, a condition and a function can be determined based on the description. If the condition is met, the function of the motor vehicle 105 is intended to be executed. The condition is met when a situation of the motor vehicle 105 corresponds to the condition. Usually, the conditions and the functions are linguistically included in the description in the form of an if-then construction. The description may include one or more natural language sentences. Optionally, an input using different predetermined human languages may be allowed.

On the basis of the condition, an external information source 155 can be determined in a step 215, which information source can provide a parameter that can more accurately characterize a situation of the motor vehicle 105 in relation to the condition. In particular, the external information source 155 can provide a parameter of the situation that is relevant to checking whether the condition is met. For example, if the condition concerns weather, a weather service, which can provide a weather parameter, such as a temperature in the region of the motor vehicle 105, can be determined as an external information source 155.

In a step 220, a first embedding can be determined based on the condition. The embedding typically includes a vector with a high number of dimensions, in which case the embedding can be considered to be an internal representation of the condition. A separate embedding can be determined for the function. The function or its embedding can be assigned to the first embedding. The function can also be converted into a machine-related description of the function and assigned to the first embedding. The machine-related function can be directly implemented by the motor vehicle 105 or a device included therein and connected to the interface 140 in order to control or execute the function. It is preferred for the first embedding to be stored in the vector-oriented database 135.

Steps 205 to 220 can only be performed once with respect to a technique described herein.

In a step 225, a driving state of the motor vehicle 105 can be determined. The driving state can distinguish, for example, whether the motor vehicle 105 is driving, stationary or parked. Further gradations can also be determined.

In a step 230, a parameter indicating a situation of the motor vehicle 105 can be determined. In one embodiment, as many parameters as possible, which indicate a situation of the motor vehicle 105, are determined. In another embodiment, those parameters which are relevant to determining the situation of the motor vehicle 105 with respect to a stored condition from step 210 can be specifically determined.

In a step 235, a parameter from an external information source 155 can also be determined. The parameter and/or the external information source 155 can be determined based on determinations from step 215.

In a step 240, a second embedding, which represents the situation of the motor vehicle 105, can be determined on the basis of the determined parameters. The second embedding can also be stored in the database 135.

Steps 225 to 240 can be performed multiple times in succession. In particular, steps 225 to 240 can be performed periodically or continuously. Optionally, a frequency or speed at which these steps are performed depends on a driving state of the motor vehicle 105 that is determined in step 225.

In a step 245, it can be determined whether a similarity between the first embedding and the second embedding exceeds a predetermined value. In other words, it can be determined whether the embeddings differ from each other by less than a predetermined degree. If this is the case, the function of the motor vehicle 105 determined in step 210 can be controlled or initiated in a step 250. Optionally, the function can be controlled on the basis of a parameter that is part of the situation of the motor vehicle 105. A type of control or a parameter of the controlled function can be determined on the basis of the function description from step 210.

In an exemplary application, a person 110 could set up a rule for the automatic control of a function of the motor vehicle 105 by inputting as an input (cf. step 205): "If the weather is nice, please open my window and activate the expressive mode".

In step 210, it can be recognized that two functions of the motor vehicle 105 need to be controlled, namely the opening of a window and the activation of a predetermined driving mode, namely the "expressive" mode. In addition, it can be determined that the condition presupposes nice weather. Both details cannot be easily resolved, since it is not clear at first which window is intended to be opened, what is meant by nice weather and where the weather should be determined.

In step 215, it is possible to determine how the missing information can be arrived at. To determine which window is to be opened, speech recognition can be carried out on board the motor vehicle 105, which determines the place from which an acoustic input has been made. The weather should be determined at the location of the motor vehicle 105, for which a geographical position of the motor vehicle 105 must be determined, for example by means of a positioning device of the motor vehicle 105. It is possible to ask a weather service about the weather prevailing in the region of the motor vehicle with regard to the geographical position.

If no other criteria are defined for "nice" weather, a corresponding statement from the weather service can be evaluated. Alternatively, a common definition can be used, for example based on world knowledge of the executing LLM. In step 220, the first embedding can be determined. A description of "nice" weather can be part of the first embedding.

The current position and the weather are not usually determined at the time at which the condition is set and these parameters are preferably not included in the first embedding either. Instead, it can be stored in step 215 that a geographical position needs to be determined for the determination of the second embedding in order to ask about weather prevailing at this position. This determination can be carried out later, e.g. in step 230, in order to determine the second embedding based on current parameters.

If the motor vehicle 105 is in use, the second embedding, which reflects the situation of the motor vehicle 105, can be determined continuously in steps 225 to 240. This situation may include weather prevailing at the geographical position of the motor vehicle 105 or its quality in terms of its "niceness". If a sufficient match between the embeddings is determined in step 245, the stored functions can be controlled automatically. Optionally, a confirmation from a person 110 on board the motor vehicle 105 can be obtained before the determined function is actually executed.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### Reference signs

100 Control system

105 Motor vehicle

110 Person

115 Mobile device

120 Apparatus

125 Processing device

130 Large Language Model, LLM

135 Vector-oriented database

140 Interface

142 Sensor

145 User interface

150 Communication device

155 External information source

160 External location

200 Method

205 Record utterance

210 Determine condition and function

215 Determine external information source

220 Determine first embedding

225 Determine driving state

230 Determine parameters of a situation of the motor vehicle

235 Determine parameters from external information source

240 Determine second embedding

245 Similarity > predetermined value?

250 Control function of the motor vehicle

What is claimed is:

1. A method for controlling a function of a motor vehicle, comprising:
recording a linguistic description of conditional function execution, the linguistic description comprising a condition and a function of the motor vehicle to be executed when the condition is met;
determining, utilizing a large language model (LLM), a first embedding on the basis of the condition;
determining parameters of a situation of the motor vehicle;
determining a second embedding on the basis of the parameters; and
automatically executing the function when the first embedding has a predetermined similarity to the second embedding.

2. The method according to claim 1, wherein the situation is determined on the basis of a driving state of the motor vehicle.

3. The method according to claim 1, wherein the description is recorded and processed in the form of an acoustic utterance by a person.

4. The method according to claim 1, wherein the similarity is determined on the basis of a Euclidean distance, a scalar product, a cosine similarity or a Manhattan metric.

5. The method according to claim 1, wherein the situation comprises at least one of a driving state of the motor vehicle, weather prevailing in the region of the motor vehicle, a person on board the motor vehicle, a planned route or a destination of the motor vehicle.

6. The method according to claim 1, further comprising:
determining environment information relating to the motor vehicle;
wherein the second embedding is determined on the additional basis of the environment information.

7. The method according to claim 6, wherein an information source for the environment information is determined on the basis of the condition.

8. The method according to claim 1, wherein a probable situation of the motor vehicle is predicted.

9. A control system for controlling a function of a motor vehicle, the system comprising:
an input device for recording a linguistic description of conditional function execution, the linguistic description comprising a condition and a function of the motor vehicle to be executed when the condition is met;
at least one sensor configured to determine parameters of a situation of the motor vehicle;
an interface to a large language model (LLM), which is configured to determine a first embedding on the basis of the condition and a second embedding on the basis of the parameters; and
a processing device configured to execute the function when the first embedding has a predetermined similarity to the second embedding.

10. The control system according to claim 9, wherein the LLM is included in the control system.

11. The control system according to claim 9, further comprising:
a vector-oriented database for storing embeddings;
wherein the database is configured to determine a similarity between stored embeddings.

12. The control system according to claim 9, further comprising an interface to an information source remote from the motor vehicle, which is configured to provide environment information for the motor vehicle.

13. An apparatus for a motor vehicle, comprising:
a device configured to determine that a situation of the motor vehicle has a predetermined similarity to a predetermined condition, wherein:
a first embedding is assigned to a linguistic description of the condition; and
a second embedding is assigned to parameters of the situation; and
a control device configured to control a predetermined function of the motor vehicle, which is associated with the condition, if the first embedding has a predetermined similarity to the second embedding.

14. A motor vehicle comprising an apparatus according to claim 13.
